(19) United States
(12) Patent Application Publication
(10) Pub. No.: US 2010/0227588 A1
(43) Pub. Date: Sep. 9, 2010

(54) Methods and Apparatus for a SIM-Based Firewall

(76) Inventor: Ciaran Bradley, Sutton (IE)

Correspondence Address: CHOATE, HALL & STEWART LLP, TWO INTERNATIONAL PLACE, BOSTON, MA, 02110, US

(21) Appl. No.: 12/303,878

(22) PCT Filed: Jun. 8, 2007
(86) PCT No.: PCT/IB07/01105

§ 371 Date: Dec. 8, 2008

Related U.S. Application Data
(60) Provisional application No. 60/804,221, filed on Jun. 8, 2006.

(51) Int. Cl. H04M 1/67

(52) U.S. Cl. 455/411

(57) ABSTRACT

A method for using a SIM-based firewall to filter and regulate events that may occur in a wireless device or SIM card may include: reading configuration settings; registering with a wireless device, and starting timers; detecting an event; determining whether the event matches criteria for allowance; and, if the event matches, allowing the event. If the event is not allowed, the method may then comprise terminating the event; determining whether to notify the external interface; and potentially transmitting an indication to the external interface. Indications may also be transmitted to a remote system that the event was detected and/or blocked.

### RELATED APPLICATIONS

The present application claims priority to U.S. Provisional Patent Application Ser. No. 60/804,221, filed Jun. 8, 2006, and titled METHODS AND APPARATUS FOR A SIM-BASED FIREWALL.

### FIELD OF THE INVENTION

The present invention relates to wireless devices employing subscriber identification modules, and means for filtering and regulating incoming and outgoing communications, data and events on such devices.

### BACKGROUND OF THE INVENTION

Many circumstances exist in which the ability to effectively filter incoming and outgoing events on a wireless device is desirable. However, the current state of the art may not adequately allow for fine-grained control of the plurality of data and communications that may be sent and received by modern wireless devices in a wireless telephony network.

For example, the fixed dialing number (FDN) service of Global System for Mobile Communications (GSM) and Universal Mobile Telecommunications System (UMTS) may allow outgoing calls and bearer services and teleservices to be restricted but does not control the plurality of data and communications that may be received by modern wireless devices. The GSM and UMTS barred dialing number (BDN) service can prevent outgoing calls to defined phone numbers but does not control incoming calls and does not control the plurality of data and communications that can be sent and received by modern wireless devices.

Intelligent networks (IN) using Customized Applications for Mobile Network Enhanced Logic (CAMEL) or Wireless Intelligent Network (WIN) technologies deployed in a wireless telephony network may provide some degree of control over the data and communications that may be sent and received by modern wireless devices in a wireless telephony network but they are complicated, expensive and time consuming to deploy.

Thus, there exists a need for a solution that offers efficient fine-grained control of the plurality of data, communications and events that can be sent and received by wireless devices in a wireless telephony network.

### SUMMARY OF THE INVENTION

The present invention is related to systems and methods for providing fine-grained control of the plurality of data, communications and events that can be sent and received by wireless devices in a network.

In one aspect, the present invention is a method for using a SIM-based firewall to filter and regulate events that may occur in a wireless device or SIM card. In brief overview, the method comprises: reading configuration settings; registering with a wireless device, and starting timers; detecting an event; determining whether the event matches criteria for allowance; and, if the event matches, allowing the event. If the event is not allowed, the method may then comprise terminating the event; determining whether to notify the external interface; and potentially transmitting an indication to the external interface. The method may also comprise transmitting to a remote system an indication that the event was detected and/or blocked.

In another aspect the present invention is the method for remotely managing a SIM-based firewall. In brief overview, the method comprises: receiving a remote management event from the network. The remote management event may comprise one or more of: instructing the SIM-based firewall to stop; instructing the SIM-based firewall to re-start; modifying the configuration settings of the SIM-based firewall; saving the modified configuration settings of the SIM-based firewall; modifying the executable files and libraries of the of the SIM-based firewall; and saving the modified executable files and libraries of the SIM-based firewall.

In another aspect, the present invention is a digital electronic system or systems for performing any of the methods described above.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1A is a block diagram depicting one embodiment of a wireless device incorporating a SIM-based firewall connected to a network;

FIG. 1B is a block diagram depicting one embodiment of a network;

FIGS. 2A and 2B are flow diagrams depicting various embodiments of an event being processed by a SIM-based firewall;

FIG. 3 is a flow diagram depicting one embodiment of a method performed by a SIM-based firewall for filtering events; and

FIG. 4 is a flow diagram depicting one embodiment for remotely managing a SIM-based firewall.

### DETAILED DESCRIPTION OF THE INVENTION

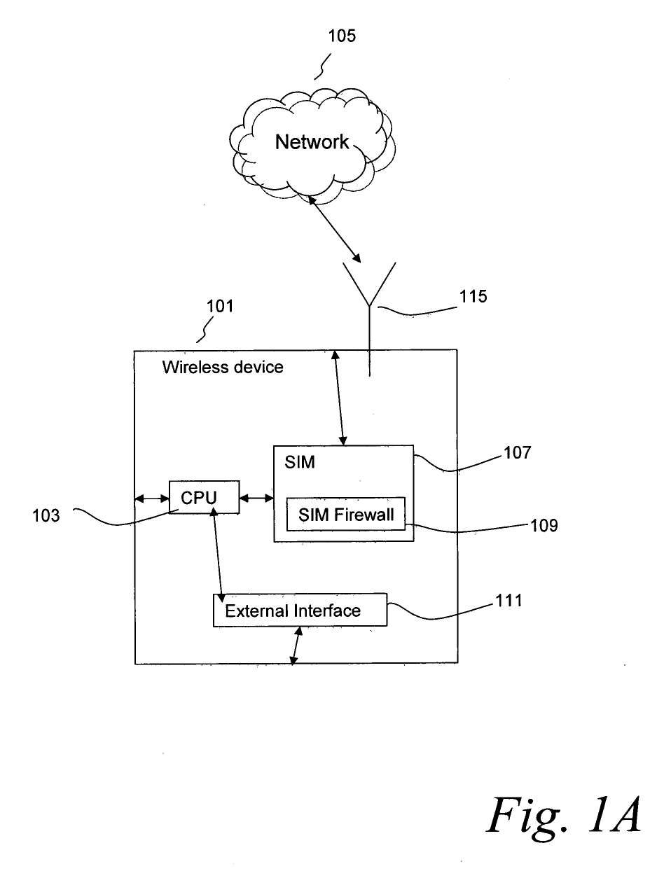

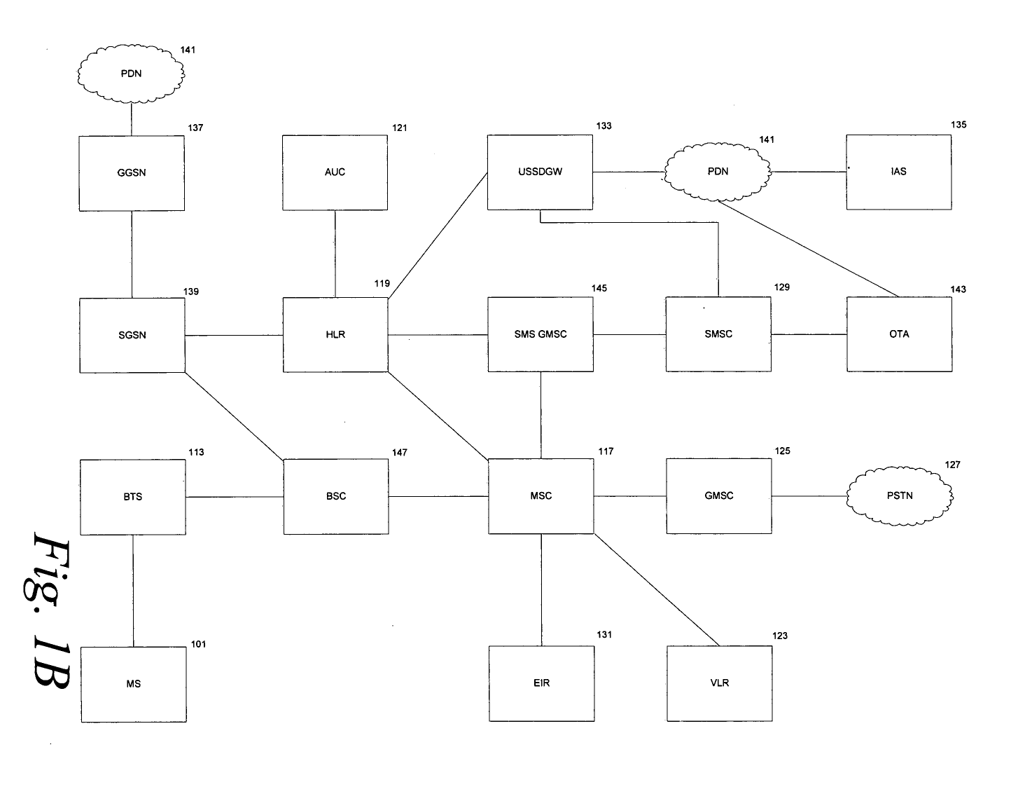

Referring now to FIG. 1A, a block diagram depicting one embodiment of a wireless device incorporating a SIM-based firewall connected to a network is shown. In brief overview, a wireless device 101 comprises a Central Processing Unit (CPU) 103, a Subscriber Identity Module (SIM) 107, a SIM-based firewall (109), a radio transceiver (115) and an external interface (EI) 111. The wireless device may be in communication with one or more networks 105, and may be in communication with one or more transmitter/receiver stations 113.

Still referring to FIG. 1A, now in greater detail, a wireless device 101 is shown. Herein the term wireless device refers to any device capable of transmitting and receiving voice and/or data (non-voice) information to and from a network without the use of wires, cables or other tangible transmission media. In one embodiment, the wireless device 101 may comprise a mobile phone. In other embodiments, a wireless device may comprise a cellular phone, a smart phone, a fixed-mobile convergence phone, a satellite phone, a wireless data card, a wireless personal digital assistant (PDA), a wireless modem or computers and electronic systems that communicate wirelessly.

In the embodiment shown, the wireless device 101 comprises a SIM 107. A SIM 107 may be a smart card that may comprise one or more of: CPU, Cryptographic Processor, Read only memory (ROM), Random access memory (RAM), Electrically-Erasable Programmable Read-Only Memory (EEPROM) and input/output circuits.

A SIM 107 may be used to store unique subscription and authentication information about the owner of the SIM 107, the network that the SIM 107 has permission to connect to, the services that the SIM 107 may access on a network and an address book of telephone numbers. A SIM 107 may comprise one or more valued added applications. Such applications may comprise: banking, biometric, medical, security, productivity, identity management, digital signature, public key infrastructure (PKI), multimedia, ticketing, digital rights management, gaming, and loyalty applications. The SIM applications may employ SIM Application Toolkit (SAT) technology or other smart card application technologies.

In another embodiment a wireless device may comprise a Universal Integrated Circuit Card (UICC) in place of a SIM. A UICC may comprise one or more Identity Module (IM) technologies of: GSM Subscriber Identity Module (SIM), UMTS Internet Protocol Multimedia Services Identity Module (ISIM), CDMA Removable User Identity Module (R-UIM), plus value added applications. The UICC applications may use one or more technologies of: USAT (Universal SIM Application Toolkit), CCAT (CDMA Card Application Toolkit), CAT (Card Application Toolkit), UATK (UIM Application Toolkit) or other smart card technologies. In this context SIM 107 is used generically to represent both the SIM card and the UICC with a USIM, or other IM, application residing on the UICC.

In the embodiment shown, a SIM 107 may comprise a SIM-based firewall application 109, herein referred to as a SIM firewall 109. A SIM firewall 109 may comprise programmable logic that that detects, filters and regulates data, communications and events that pass, in either direction, between a network 105, a wireless device 101, SIM 107, and an external interface 111 of the wireless device. The SIM firewall 109 may evaluate the data, communications and events against one or more configurable criteria. If the data, communications and events match the specified criteria they may be rejected, or allowed to continue in either direction between a network 105, a wireless device 101, SIM 107 and the external interface 111 of the wireless device.

In one embodiment, the SIM firewall 109 may be transferred and installed onto the SIM 107 as part of the manufacturing process of the SIM 107, using Over The Air (OTA) management with SMS or Cell Broadcast (CB) messages, using Bearer Independent Protocol (BIP), using Java Remote Method Invocation (RMI), using Java 2 Micro Edition (J2ME) midlets that support the Security and Trust Services API for J2ME (SATSA) specification, using the operating system of the wireless device, using an application on the wireless device, using a Card Acceptance Device (CAD) or other smart card reader that is physically connected to the SIM, using contactless smart card technology that is able to communicate with the SIM by means of short range radio frequency technology.

In the embodiment shown, the SIM firewall 109 may be managed remotely over the network using one or more of: SMS messages, Cell Broadcast messages, BIP, Java RMI, J2ME midlets that support the SATSA specification or other remote management technologies, the operating system of the wireless device, applications on the wireless device. The embodiments may allow a person to manage a SIM firewall 109 without being physically connected to the SIM 107.

In one embodiment, the SIM firewall 109 may be managed locally using a Card Acceptance Device (CAD) or other smart card reader that is physically connected to the SIM; using contactless smart card technology that is able to communicate with the SIM by means of short range radio frequency technology.

In the embodiment shown, the SIM firewall may start automatically when the mobile device powers up and may stop when the mobile device powers down. The SIM firewall may also be stopped and started by any or all of the local and remote management technologies described herein.

In the embodiment shown, a wireless device 101 may include an external interface (EI) 111. An external interface may comprise one or more of: man-machine interface (MMI) and machine to machine interface (M2M). An MMI may comprise any device allowing a person to interact with or operate the wireless device, including without limitation a screen, camera, finger print reader, a keyboard, a keypad, a microphone, optical sensor, audio sensor, a motion sensor, a speaker. An M2M may comprise any device allowing another device to exchange data with the wireless device or operate the wireless device, including without limitation, an RS-232 serial communication data port, manufacturer's proprietary communication data port, Universal Serial Bus (USB) data port, Bluetooth transceiver data port, Ultra Wideband (UWB) transceiver data port, Infrared data port, other short range radio frequency technology data port, or other data port that allows a wireless device to communicate with another device.

In the embodiment shown, the wireless device 101 may be in communication with a network 105. A network 105 may comprise any known network capable of receiving wireless transmissions.

Referring now to FIG. 1B, an example network 105 is shown. A network 105 may comprise one or more, and any or all of the following: wireless devices described in the art as Mobile Stations (MS) 101; Base transceiver stations (BTS) 113, Base station controllers (BSC) 147, Mobile switching centers (MSC) 117, Home location registers (HLR) 119, Authentication centers (AuC) 121, Visitor location registers (VLR) 123, Gateway mobile switching centers (GMSC) 125, Public Switched Telecomm Networks (PSTN) 127, Short Message Service centers (SMSC) 129, Equipment Identity Registers (EIR) 131, Unstructured Supplementary Services Data (USSDGW) gateways 133, Internet Application Servers (IAS) 135, Gateway General Packet Radio Service (GPRS) Support Nodes (GGSN) 137, Serving GPRS Support Nodes (SGSN) 139, Packet Data Networks (PDN) 141, SIM OTA Servers (OTA) 143, and SMS Gateway MSCs (SMS GMSC) 145. The components of a network 105 may be connected in any topology using any interconnect technology.

The network 105 described herein may comprise a generalized GSM/GPRS network, though a person skilled in the art would appreciate that the invention may be deployed in alternative networks employing different bearers, protocols, technologies, architectures and topologies. In other embodiments, a network 105 may employ one or more of: Universal Mobile Telecommunications Service (UMTS), Code Division Multiple Access (CDMA including CDMA2000 1x, CDMA2000 1xEV-DO, CDMA2000 1xEV-DV, CDMA TIA/EIA/ANSI-95A/B), GPRS, Enhanced Data rates for GSM Evolution (EDGE), Wideband Code Division Multiple Access (W-CDMA), Personal Digital Cellular (PDC), Integrated Digital Enhanced Network (iDEN), High-Speed Uplink Packet Access (HSUPA) UMTS, High Speed Downlink Packet Access (HSDPA) UMTS, Freedom of Mobile Multimedia Access (FOMA), Time Division-Synchronous Code Division Multiple Access (TD-SCDMA), Time Division-Code Division Multiple Access (TD-CDMA), UMTS-Time division duplexing (UMTS-TDD), UMTS Long Term Evolution (LTE), Frequency division multiplexing (FDM), Frequency division duplexing (FDD), Direct Sequence Ultra wide band (DS-UWB), Internet Protocol multimedia Subsystem (IMS), Session Initiation Protocol (SIP), Orthogonal Frequency Division Multiple (OFDM), Orthogonal Frequency Division Multiple Access (OFDMA), Software-defined radio (SDR), Personal Communications Service (PCS), High-Speed Circuit-Switched Data (HSCSD), Ultra Wideband (UWB), Wideband Integrated Dispatch Enhanced Network (WiDEN), Unlicensed Mobile Access (UMA), WiMax IEE 802.16, WiFi IEE 802.11, Wireless Local Area Network (WLAN), Circuit Switched Data (CSD), wireless wide-area network (WWAN), Voice over Internet Protocol (VoIP), time division multiple access (TDMA), Wireless Broadband (WiBro), Time Division CDMA (TD-CDMA), Voice over WLAN(VoWLAN), Multiple-input multiple-output (MIMO), Variable-Spreading-factor Spread Orthogonal Frequency Division Multiplexing, Push to Talk (PTT), Signaling System 7 (SS7), SS7 over IP, Message Transfer Part-Level 2 Peer-to-Peer Adaptation Layer (M2PA), Message Transfer Part—Level 3 User Adaptation Layer (M3UA), Common Channel Signaling System 7 (CCS7), Transmission Control Protocol/Internet Protocol (TCP/IP), Hyper Text Transfer Protocol (HTTP), Hyper Text Transfer Protocol Secure (HTTPS), User Datagram Protocol (UDP).

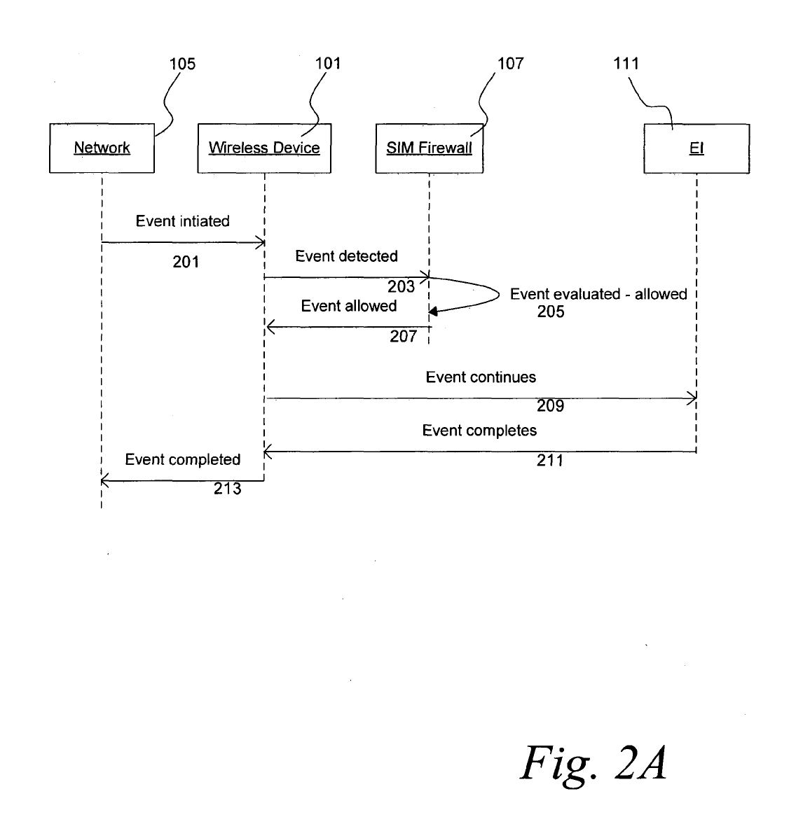

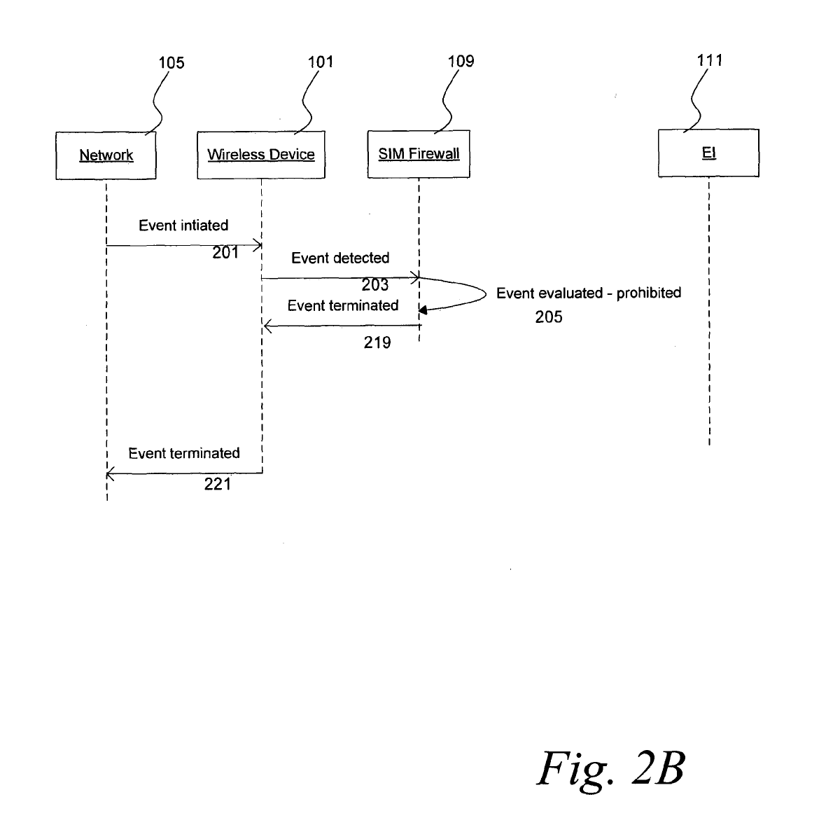

Referring now to FIG. 2A, a flow diagram depicting one embodiment of an event being processed by a SIM-based firewall is shown. In brief overview, a network 105 initiates an event (step 201) which is received by the wireless device. A SIM-based firewall 109 operating inside the wireless device 101 detects the event (step 203), and evaluates the event (step 205). The SIM-based firewall allows the event (step 207) and the event then continues (step 209) where it is passed to the EI 111. The event may then complete by a transmission from the EI 111 to the wireless device (step 211) which is then passed to the network (step 213).

Still referring to FIG. 2A, now in greater detail, in the embodiment shown a network 105 initiates an event (step 201) which is received by the wireless device. The event may comprise one or more of: voice call, video call, PTT call, cell broadcast message, SMS message, instant messaging message, Wireless Application Protocol (WAP) push message, Multimedia Messaging Service (MMS) notification, SIM update message, Enhanced Messaging Service (EMS) message, Electronic mail notification, Electronic mail message, incoming encrypted/unencrypted data connection notification, incoming encrypted/unencrypted data connection, mobile TV data, paging/polling of the wireless device, incoming radio, video or other multi media content, wireless device operating system update, wireless device application update, wireless device firmware update, installation of a new wireless device application.

In the embodiment shown, the event may then be detected by a SIM-based firewall application running on a SIM (step 203) in the wireless device. In some embodiments, the SIM firewall may have previously registered with the wireless device or the wireless device operating system that it is to be notified of one or more events that may be received from the network. In one embodiment, after the event is received by the wireless device, information about the event and control over the incoming event may be passed from the wireless device to the SIM firewall. In other embodiments, the SIM may actively detect one or more events.

In the embodiment shown, the event may then be evaluated by the SIM firewall against configurable criteria (step 205) that may be stored on the SIM or wireless device. The criteria may comprise one or more of: event type, incoming or outgoing event, data type, data content, application type, protocol, bearer, source address, destination address, time, date, previous amount of usage, and previous number of events.

In one embodiment, the SIM firewall may evaluate source and destination addresses by partial and/or full matches. The SIM firewall may evaluate addressing schemes that may comprise one or more of: Internet protocol (IPv4 and/or IPv6) addresses and/or port numbers, Uniform Resource Locator addresses, Email addresses, GPRS APN (Access Point Name)s, MSISDN (Mobile Station Integrated Services Digital Network) numbers, USSD service codes, Cell IDs, IMEI (International Mobile Equipment Identity), IMSI (International Mobile Subscriber Identity), SMS port number, wireless device port number, other addressing schemes supported by the wireless device.

In another embodiment, the SIM firewall may evaluate events by any combination of one or more time components. For example a parent may specify that a child cannot use a mobile phone to make and or receive calls from friends during school hours. Or, for example, a company manager may specify that company mobile phones can only be used during working hours on weekdays. The SIM firewall may also evaluate events on a configurable scheduled basis, e.g. it may evaluate a condition every 10 seconds.

In the embodiment shown, if the event is not prohibited by the configured criteria the SIM-based firewall may allow the event to proceed (step 207) and control of the event is passed from the SIM to the wireless device and then to the external interface of the wireless device (step 209).

In the embodiment shown, the external interface of the wireless devices may then process the event (step 209). The event may be processed by one or more of: the M2M or MMI interface of the external interface.

In the embodiment shown, the event may complete by a transmission from the external interface 111 to the wireless device (step 211) which is then passed to the network (step 213).

Although in the embodiments shown after the SIM-based firewall allows the event to proceed (step 207) control of the event is passed from the SIM to the wireless device and then to the external interface of the wireless device (step 209), in other embodiments control of the event may be passed to one or more entities of: the wireless device, applications on the wireless device, the operating system of the wireless device, the firmware of the wireless device, the SIM, applications on the SIM, for processing. The event may complete by a transmission from the receiving entity, which may then be passed to the network (step 213).

Referring now to FIG. 2B, a flow diagram depicting another embodiment of an event being processed by a SIM-based firewall is shown. In brief overview, a network 105 initiates an event (step 201) which is received by the wireless device. A SIM-based firewall 109 operating inside the wireless device 101 detects the event (step 203), and evaluates the event (step 205). The SIM-based firewall prohibits the event and the event is terminated (step 219). The event may then complete by a transmission from the wireless device to the network (step 221).

Still referring to FIG. 2B, now in greater detail, in the embodiment shown a network 105 initiates an event (step 201) which is received by the wireless device. This step may be performed as described in connection with FIG. 2A.

In the embodiment shown, the event may then be detected by a SIM-based firewall application running on a SIM (step 203). This step may be performed as described in connection with FIG. 2A.

In the embodiment shown, the event may then be evaluated by a SIM-based firewall application against configurable criteria (step 205) that may be stored on the SIM or wireless device. This step may be performed in accordance with any of the embodiments described herein. In the embodiment shown, the event is prohibited by the configured criteria and the SIM firewall prevents the event from continuing.

The event is then terminated (step 219) and control is passed to the wireless device. In some embodiments, the termination of the event may complete by a transmission from the wireless device to the network (step 221).

Although in the embodiments shown in FIGS. 2A and 2B, an event is initiated by a network (step 201), in other embodiments a SIM-based firewall may detect and evaluate other events that may be initiated by a wireless device (101), a SIM (107), applications on a SIM, the external interface of a wireless device (111), or events that may be inferred by a SIM-based firewall (109).

Events initiated by a wireless device may include without limitation: events generated by timers, events generated by external or internal card readers, events relating to accessing or modifying the file system or memory of the wireless device, events relating to accessing or modifying accessing external storage technologies such as SD (Secure Digital) flash, MMC (Multi Media Card) flash, Compact Flash storage, Memory Sticks, Flash RAM/ROM, EPROM (Erasable Programmable Read-Only Memory), EEPROM (Electrically-Erasable Programmable Read-Only Memory), solid state memory, hard drives, NAND flash storage, events relating to starting or terminating an application or service that executes on a wireless device, events generated by the operating system of a wireless device, events relating to starting or terminating a data session on a wireless device, events relating to receiving a Bluetooth communication from another device, events relating to receiving an Infra red communication from another device, and events relating to receiving a communication from another device using short range radio technology.

Events initiated by the external interface of a wireless device may include: events relating to a user manipulating a button on the wireless device, events relating to a user manipulating a joystick on the wireless device, events relating to a user manipulating user input mechanisms including voice control of the wireless device, events relating to a user sending an SMS message, events relating to a user sending an MMS message, events relating to a USSD message, events relating to a user sending an instant message, events relating to a user starting or terminating a voice call, events relating to a user starting or terminating a video call, events relating to a user starting or terminating a VoIP call, events relating to a user starting or terminating a PTT call, events relating to a user starting or terminating a Bluetooth data session, events relating to a user starting or terminating a infra red data session, events relating to a user starting or terminating a data session, events relating to a user starting or terminating a service on the wireless device or SIM, and events relating to a user starting or terminating an application on the wireless device or SIM, AT commands sent to the wireless device via the M2M, AT commands sent to the SIM via the M2M, other programmatic commands sent to the wireless device or SIM via the M2M.

Events initiated by a SIM may include: events generated by applications on the SIM, events relating to accessing or modifying the file system or memory of the SIM, events relating to accessing or modifying encrypted or otherwise protected files or memory of the SIM, and events relating to cryptographic operations applied to files or memory of the SIM.

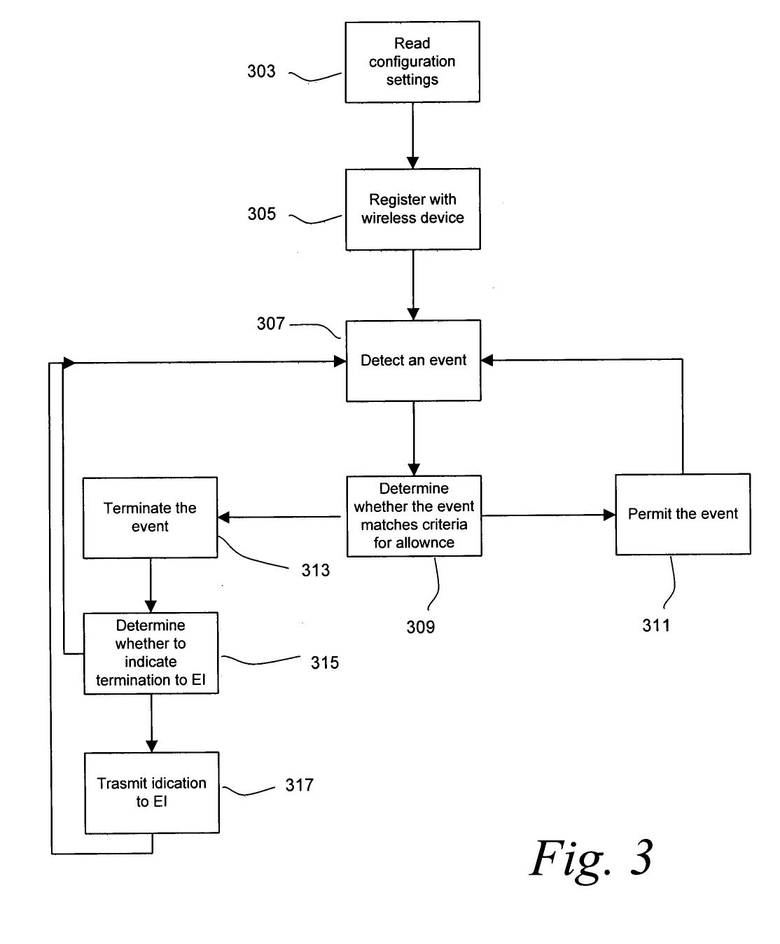

Referring now to FIG. 3, a flow diagram depicting one embodiment of a method performed by a SIM firewall for filtering events is shown. In brief overview, the method comprises: reading configuration settings (step 303); registering with a wireless device, and (step 305); detecting an event (step 307); determining whether the event matches criteria for allowance (step 309); and, if the event matches, allowing the event (step 311). If the event is not allowed, the method may then comprise terminating the event (step 313); determining whether to notify the EI (step 315); and potentially transmitting an indication to the EI (step 317).

Still referring to FIG. 3, now in greater detail, in the embodiment shown, the SIM firewall reads configuration settings (step 303). In one embodiment, the firewall reads configuration settings from a file stored on the SIM. In other embodiments, the firewall reads configuration settings from the memory of the SIM. In still other embodiments, the firewall reads configuration settings from a file otherwise stored on the wireless device.

In one embodiment, a configuration setting comprises a file or area of memory on a wireless device or SIM. The file or area of memory may comprise one or more of: the source addresses, destination addresses, protocols, bearer, event types, incoming or outgoing directions, data types, data content, applications, resources, times during which an event may be allowed or prohibited, whether the external interface should be informed if an event is prohibited, and whether an event matching one or more of these criteria should be allowed or prohibited.

After the SIM-based firewall reads the configuration settings (step 303), it may then register with a wireless device, and may start any required timers (step 305). The SIM firewall registers with the wireless device any events specified in the configuration settings that it is to be notified of by the wireless device.

In one embodiment the SIM firewall may start one or more timers to expire at times specified in the configuration settings. In other embodiments the SIM firewall may request the wireless device to start one or more timers to expire at intervals defined in the configuration settings. When a timer expires the SIM firewall is notified of the event by the wireless device

In the embodiment shown, when the SIM firewall detects an event (step 307), the SIM firewall determines whether the event matches the criteria for allowance (step 309). If the event matches the criteria for allowance the event is permitted (step 311) whereupon the SIM firewall is ready to detect another event (step 307). Said determination may be made using any criteria and information described herein. In other embodiments, a SIM firewall may determine whether an event matches criteria for denial. In still other embodiments, a SIM firewall may determine whether to allow an event based on both criteria for allowance and criteria for denial. In one embodiment, a SIM firewall may comprise a hierarchy of criteria. For example, a SIM firewall may comprise criteria to deny all outgoing calls to a given area code, but allow calls from a particular number within said area code.

If the event does not match the criteria for allowance the event may be terminated (step 313) whereupon the SIM firewall is ready to detect another event (step 307). In some embodiments, the SIM firewall accesses the configuration settings to determine if the external interface should be informed that a prohibited event has been terminated (step 315) whereupon the SIM firewall is ready to detect another event (step 307).

In other embodiments, the SIM firewall may transmit an indication to the network that an event was terminated (step 313), or permitted (step 311). The transmission may use one or more of: SMS message, USSD, BIP, HTTP/HTTPS, GPRS, TCP/IP, UDP or any other communication technologies

In some embodiments, the network or the wireless device may subsequently send a notification to a person, wireless device, computer, server, or any other electronic system that the event was detected and/or terminated. The network or wireless device may send the notification using electronic mail, SMS, EMS, MMS, instant message, voice call, video call, VOIP call, PTT call or voice call that uses interactive voice response (IVR), voice extensible markup manguage (VXML) and text to speech (TTS) technologies, HTTP/S, TCP/IP, UDP, extensible markup manguage (XML) or other communication technologies. For example, the network may send an email notification to a parent's email address that a call from a given phone number was blocked from reaching a child's phone. Or, for example, a wireless device may send a notification to a log accessible by a corporate accounts manager that a user of the device was blocked from placing a call to a given area code. Or for example, a wireless device may send a text message to a parent's mobile device that a given internet site or IP address is being accessed by a child's mobile phone.

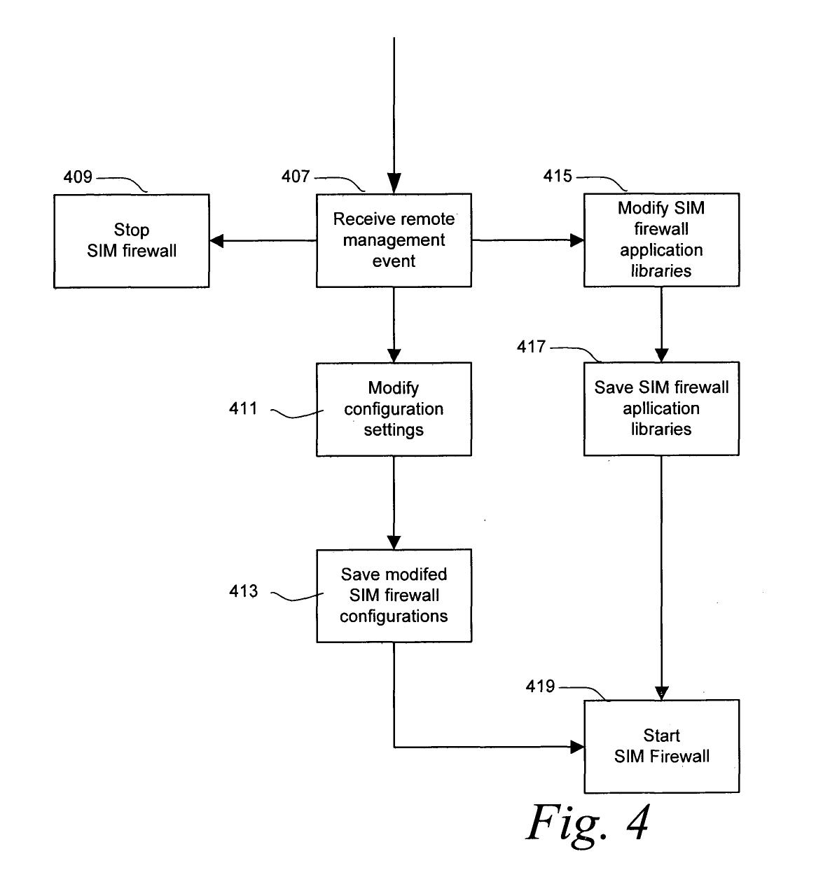

Referring now to FIG. 4, a flow diagram depicting one embodiment of a method performed by a SIM firewall for processing a remote management event is shown. In brief overview, the method comprises: receiving a remote management event (step 407) from a network. The remote management event may comprise one or more of: instructing the SIM firewall to stop (step 409); instructing the SIM firewall to re-start; modifying the configuration settings (step 411) of the SIM firewall; saving the modified configuration settings (step 413) of the SIM firewall; modifying the executable files and libraries (415) of the of the SIM firewall; saving the modified executable files and libraries (417) of the SIM firewall; and restarting the SIM firewall (419).

In other embodiments a SIM firewall may perform the above method for processing local management events. This method may be performed in accordance with any of the embodiments described herein. In still other embodiments the remote management event may be received, and in some cases modified, by an application on the wireless device, or the operating system of the wireless device and then transferred to the SIM firewall or SIM.

Still referring to FIG. 4, now in greater detail, in the embodiment shown, a SIM firewall receives a remote management event from a network (step 407). This step may be performed in accordance with any of the embodiments described herein.

In the embodiment shown, a SIM firewall may receive a remote management event comprising instructions for the SIM firewall to stop running (step 409). The instructions to stop running may comprise instructions to stop running permanently; to stop running until the wireless device is powered on at which point the SIM firewall will re-start; or to stop running until instructed to start again. Upon receiving said instructions, the SIM firewall may then stop running accordingly.

In the embodiment shown a SIM firewall, or the SIM operating system, may receive a remote management event comprising instructions to modify the configuration settings (step 411). The instructions to modify the configuration settings may contain instructions and data to overwrite the existing configuration settings with new configuration settings, or delete the existing configuration settings and replace them with new configuration settings data.

In the embodiment shown, the SIM firewall, or the SIM operating system, then saves the new configuration settings to persistent storage on the SIM, or wireless device (step 413). The SIM firewall may use the configuration settings immediately, or it may restart (step 419) and read the configuration settings.

In the embodiment shown, a SIM firewall, or the SIM operating system, may receive a remote management event comprising instructions to modify the libraries and files of the SIM firewall application (step 415). The instructions to modify the libraries and files the SIM firewall may contain instructions and the data necessary to delete the libraries and files and replace them with new libraries and files, or overwrite the libraries and files with new libraries and files. In other embodiments the instructions to modify the libraries and files of the SIM firewall may contain instructions to download new libraries and files from a location on the network.

The SIM firewall, or the SIM operating system, then saves the files and libraries to persistent storage on the SIM or wireless device (step 417). The SIM firewall then uses the new libraries and files immediately, or it may restart (step 419) to use the new libraries and files.

In some embodiments, a person, wireless device, computer or electronic system may use the methods described to remotely set the configuration settings of a SIM firewall. In one embodiment, a person using an internet web browser connects to a website that allows authorized users to modify the configuration settings of the SIM firewall. The website may then connect to a network and transmits the configuration settings to the SIM firewall. The network then transmits notifications that an event was terminated or permitted to the website, or to a wireless device or electronic system. In other embodiments a person may use SMS, MMS, EMS, instant messaging, Wireless Application Protocol (WAP), i-mode, IVR or other communication technologies to remotely set the configuration settings. In some embodiments, configuration settings may be set remotely by a user using one or more of IPTV, interactive TV, mobile web sites, voice recognition system, or voice automation system. In some embodiments, configuration settings may be set remotely by a user using a second mobile device. In one of these embodiments, the configuration settings may be sent directly from the second mobile device to the device to be configured, such as, for example, by a Bluetooth connection.

For example, a parent, having recently purchased a mobile phone for a child, may log into a website which allows the parent to specify numbers to which the phone may send and from which the phone may receive calls, and any other firewall settings. The website may then transmit the configured settings to the child's phone where they will be activated. Or, for example, a company may use a website to configure a plurality of wireless devices distributed to company employees. A manager may access the website to set a maximum number of minutes which may be used by the devices. The website may then transmit the configured settings to all devices specified by the company.

1. A method for operating a SIM-based firewall in a mobile device, the method comprising:
(a) receiving, by a SIM, an indication of an event occurring with respect to a mobile device comprising the SIM;
(b) determining, by the SIM, the event satisfies at least one condition; and
(c) blocking, by the SIM, the event.

2. The method of claim 1 wherein step (a) comprises receiving, by a SIM, an indication of the event comprising one of an outgoing call, an incoming call, an incoming text message, an outgoing text message, an outgoing text message, an MMS message, an SMS message, a USSD message, a video call, a Push To Talk call, a VOIP call, an E-mail, a Cell broadcast, an Instant Messaging message, a GRPS connection initiation, a Bluetooth connection initiation, a network connection initiation and a data connection initiation.

3. (canceled)

4. (canceled)

5. (canceled)

6. (canceled)

7. (canceled)

8. The method of claim 1, wherein the at least one condition comprises one of a telephone number of the event source, a portion of a telephone number of the event source, a geographic region of the event source, a time the event occurs, a date the event occurs, a total amount of calls previously handled via the mobile device during a given time period, a total amount of text messages previously handled via the mobile device during a given time period, a total amount of MMS messages previously handled via the mobile device during a given time period, a total amount of data previously handled via the mobile device during a given time period, a total amount of events previously handled via the mobile device during a given time period, and a property of a source address of the event.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. The method of claim 1 wherein step (c) comprises preventing, by the SIM, an event from being indicated via a user interface of the mobile device.

21. The method of claim 1 wherein step (c) comprises preventing, by the SIM, the mobile device from transmitting information related to the event.

22. The method of claim 1, further comprising registering, by the SIM, to receive indications of a predetermined set of events.

23. The method of claim 1, further comprising receiving, by the mobile device from a remote source, the at least one condition.

24. The method of claim 23, further comprising receiving, via a web site, the at least one condition for blocking; and transmitting, to the mobile device, the at least one condition.

25. The method of claim 1, further comprising receiving, via one of a voice recognition system, an automated phone answering system, a mobile internet site, and a second mobile device, the at least one condition for blocking; and transmitting, to the mobile device, the at least one condition.

26. The method of claim 1, further comprising receiving, via one of interactive TV, or internet protocol TV (IPTV), the at least one condition for blocking; and transmitting, to the mobile device, the at least one condition.

27. (canceled)

28. (canceled)

29. The method of claim 1, further comprising the step of transmitting, to a remote system, an indication that the event was detected.

30. The method of claim 29, further comprising transmitting, to the remote system, an indication that the event was blocked.

31. A SIM for use as a firewall in a mobile device, the SIM comprising:
means for receiving, by a SIM, an indication of an event occurring with respect to a mobile device comprising the SIM;
means for determining, by the SIM, the event satisfies at least one condition; and
means for blocking, by the SIM, the event.

32. The system of claim 31, wherein the means for receiving detects an event comprising one of an outgoing call, an incoming call, an incoming text message, an outgoing text message, an MMS message, an SMS message, an USSD message, a video call, a Push To Talk call, a VOIP call, an E-mail, a Cell broadcast, an Instant Messaging message, a GRPS connection initiation, a Bluetooth connection initiation, a network communication initiation and a data connection initiation.

33. (canceled)

34. (canceled)

35. (canceled)

36. (canceled)

37. (canceled)

38. The system of claim 31, wherein the means for determining the at least one condition determines that the least one condition comprises a telephone number of the event source, a portion of a telephone number of the event source, a geographic region of the event source, a time the event occurs, a date the event occurs, a total amount of calls previously handled via the mobile device during a given time. A total amount of text messages previously handled via the mobile device during a given time period, a total amount of MMS messages previously handled via the mobile device during a given time period, a total amount of data previously handled via the mobile device during a given time period, a total amount of events previously handled via the mobile device during a given time period and a property of a source address of the event.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. The system of claim 31 wherein the SIM comprises means for preventing an event from being indicated via a user interface of the mobile device.

51. The system of claim 31 wherein the SIM comprises means for preventing the mobile device from transmitting information related to the event.

52. The system of claim 31, further comprising means for registering, by the SIM, to receive indications of a predetermined set of events.

53. The system of claim 31, further comprising means for receiving, by the SIM from a remote source, the at least one condition.

54. (canceled)

55. The system of claim 31, further comprising means for transmitting, to a remote system, an indication that the event was detected.

56. The system of claim 55, further comprising means for transmitting, to the remote system, an indication that the event was blocked.

57. A method for operating a SIM-based firewall in a mobile device, the method comprising:
(a) detecting, by a SIM in a mobile device, a modification of a portion of the memory of the SIM;
(b) receiving, by the SIM, an indication of an event occurring with respect to the mobile device; and
(c) blocking, by the SIM, the event based at least in part on the detection of the modification.

58. The method of claim 57 wherein step (a) comprises receiving an indication from an operating system of the mobile device that a portion of the memory of the SIM has been modified.

59. The method of claim 57 wherein step (a) comprises receiving an indication from an operating system of the SIM that a portion of the memory of the SIM has been modified.

60. The method of claim 57 wherein step (a) comprises determining that contents of the portion of the memory are different than contents of the portion of memory at a previous time.
